(19) United States
(12) Patent Application Publication
(10) Pub. No.: US 2026/0067219 A1
(43) Pub. Date: Mar. 5, 2026

(54) SYSTEM FOR NETWORK CONGESTION CONTROL

(71) Applicant: MELLANOX TECHNOLOGIES, LTD., Yokneam (IL)

(72) Inventors: Chen TESSLER, Zichron Yaakov (IL); Yuval SHPIGELMAN, Netanya (IL); Gal DALAL, Shimshit (IL); Alexander SHPINER, Ramat Yishay (IL); Benjamin FUHRER, Tel Aviv (IL)

(73) Assignee: MELLANOX TECHNOLOGIES, LTD., Yokneam (IL)

(21) Appl. No.: 18/822,878

(22) Filed: Sep. 3, 2024

(51) Int. Cl. H04L 47/12; H04L 43/0829; H04L 47/11

(52) U.S. Cl. CPC H04L 47/12; H04L 43/0829; H04L 47/11

(57) ABSTRACT

Systems, computer program products, and methods are described for advanced congestion control using multiple congestion indicators in a networking environment. An example system may include an intelligent agent configured to learn congestion control policies. The agent may interact with real-world or simulated environments replicating real-world benchmarks. Congestion indicators such as telemetry information, packet drop metrics, congestion notification packet rate, pause frame rate, port utilization metrics, and/or the like form a comprehensive state representation of the network, enabling congestion state of the network environment. The intelligent agent evaluates these conditions using a reward function to optimize network performance. The intelligent agent may then implement a behavioral policy in response to the captured congestion indicators, thereby changing the congestion state of the network environment.

### TECHNOLOGICAL FIELD

Example embodiments of the present invention relate to a system for network congestion control.

### BACKGROUND

Network congestion occurs in computer networks when a node in the network receives traffic at a faster rate than it can process or transmit it. The imbalance between incoming and outgoing traffic leads to a buildup of data packets within the network node, causing delays, packet loss, and reduced quality of service. The consequences of network congestion are significant for both network performance and user experience. Congestion can result in increased latency, reduced data throughput, and degraded performance of applications relying on real-time data transmission.

Conventional solutions for addressing network congestion typically rely on hand-crafted behaviors. These solutions are often tailored to perform optimally under specific conditions but lack robustness when faced with changes, such as the introduction of additional flows, alterations in network topology, or varying levels of noise. Moreover, these algorithms often require adjustments to meet the specific needs of users-some may prioritize maximizing bandwidth, while others may focus on minimizing latency.

Applicant has identified a number of deficiencies and problems associated with congestion control using tunable parameters in a network environment. Many of these identified problems have been solved by developing solutions that are included in embodiments of the present disclosure, many examples of which are described in detail herein.

### BRIEF SUMMARY

Systems, methods, and computer program products are therefore provided for congestion control in a network environment.

In one aspect, a congestion control unit for network congestion control is presented. The congestion control unit configured to: deploy an intelligent agent on a network environment; capture, using the intelligent agent, congestion indicators representing a congestion state of the network environment, wherein the congestion indicators comprise at least telemetry information associated with one or more network devices in the network environment; and implement, using the intelligent agent, a behavioral policy in response to the captured congestion indicators, thereby changing the congestion state of the network environment.

In some embodiments, implementing the behavioral policy further comprises: determining, using behavioral policy parameters, actions to be executed in response to the captured congestion indicators; and executing the actions in the network environment.

In some embodiments, the congestion control unit is further configured to: determine a reward associated with the implementation of the behavioral policy; and iteratively update the behavioral policy parameters to maximize a cumulative value of the reward.

In some embodiments, determining the reward further comprises: executing a reward function for at least a subset of the captured congestion indicators based on the corresponding subset of executed actions; and calculating a reward value for the subset of executed actions based on executed reward function.

In some embodiments, the reward function for the telemetry information associated with one or more network devices in the network environment comprises: r(c₁)=−(qlen*transmissionrate−target)²−(maximumutil−util)², wherein qlen is a queue length indicating a total size of data packets waiting in an output queue at each network device, wherein transmissionrate is a rate at which data packets are transmitted within the network environment, wherein target is a predefined value representing a desired product of qlen and transmissionrate, wherein maximumutil is maximum potential port utilization indicating full bandwidth usage, and wherein util is current port utilization associated with the one or more network devices indicating network traffic as a percentage of maximum potential bandwidth.

In some embodiments, qlen is the queue length indicating the total size of data packets waiting in the output queue of a network device experiencing maximum congestion, and wherein util is current port utilization associated with a network device indicating maximum bandwidth utilization.

In some embodiments, the captured congestion indicator comprises packet drop metrics, and wherein the reward function for the packet drop metrics comprises: r(c₂)=−(packetdroprate)²+transmissionrate, wherein packetdroprate comprises a rate at which data packets are dropped in the network environment.

In some embodiments, the packet drop metrics comprise at last one of out-of-order (OOO) negative acknowledgements (NACKs), three-consecutive acknowledgements (ACKs), or explicit and/or deliberate drop indications.

In some embodiments, the captured congestion indicator comprises pause frame rate, wherein the reward function for the pause frame rate comprises: r(c₃)=−(pauserate)²+transmissionrate, wherein pauserate is a number of pause frames received.

In some embodiments, the captured congestion indicator comprises congestion notification packet rate, and wherein the reward function for the congestion notification packet rate comprises: r(c₄)=−(CNPrate)²+transmissionrate, wherein CNPrate is a number of congestion notification packets received.

In some embodiments, the congestion notification packet rate comprises a congestion notification type, wherein the congestion notification type is based on at the network environment.

In some embodiments, the captured congestion indicator comprises a port utilization metric associated with each destination network device and a round-trip time associated with data packets transmitted from and/or received by each destination network device, and wherein the reward function for the port utilization metric comprises: r(c₅)=(networkportutilization)²+transmissionrate−(RTTsample−targetRTT)², wherein networkportutilization is a port utilization rate of each destination network device, RTTsample is a measured sample of round-trip time associated with data packets transmitted from and/or received by each destination network device, wherein targetRTT is a predefined target value for round-trip time associated with data packets transmitted from and/or received by each destination network device.

In another aspect, a method for network congestion control is presented. The method comprising: deploying an intelligent agent on a network environment; capturing, using the intelligent agent, congestion indicators representing a congestion state of the network environment, wherein the congestion indicators comprise at least telemetry information associated with one or more network devices in the network environment; and implementing, using the intelligent agent, a behavioral policy in response to the captured congestion indicators, thereby changing the congestion state of the network environment.

In yet another aspect, a computer program product for network congestion control is presented. The computer program product comprising a non-transitory computer-readable medium comprising code configured to cause an apparatus to: deploy an intelligent agent on a network environment; capture, using the intelligent agent, congestion indicators representing a congestion state of the network environment, wherein the congestion indicators comprise at least telemetry information associated with one or more network devices in the network environment; and implement, using the intelligent agent, a behavioral policy in response to the captured congestion indicators, thereby changing the congestion state of the network environment.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an example system environment for advanced congestion control, in accordance with an embodiment of the present invention;

FIG. 2 illustrates example congestion control unit for congestion control, in accordance with an embodiment of the present invention;

FIG. 3 illustrates an example network environment, in accordance with an embodiment of the invention; and

FIG. 4 illustrates an example method for advanced congestion control, in accordance with an embodiment of the invention.

### DETAILED DESCRIPTION

### Overview

In scenarios where multiple network devices, each equipped with Network Interface Cards (NICs), transmit data through a single switch towards a receiving server, network congestion may a potential issue. Each NIC can transmit data at rates up to 100 Gbit/s, leading to a combined inbound rate into the switch that can reach up to 400 Gbit/s. However, the switch, acting as the congestion point, typically has a maximal outbound rate of 100 Gbit/s. This imbalance between the inbound and outbound rates can result in network congestion. To address this, congestion control algorithms may be implemented to manage the data transmission rates of the NICs. Such congestion control algorithms may be used to adjust the transmission rates to prevent congestion, thereby ensuring efficient network operation and minimizing delays or packet loss.

Congestion control algorithms can utilize various indicators from the network to adjust the sending rates of transmitting NICs. These indicators include notifications of packet discards, round-trip delay sampling, in-band flow telemetry (IFA), explicit congestion marking of data packets traversing a switch, and/or the like. By using these congestion indicators, congestion control algorithms can gather comprehensive data about the congestion state of network paths, allowing for more precise calculations of transmitting rates, enhancing the algorithm's ability to effectively manage and mitigate congestion.

Accordingly, embodiments of the invention introduce an advanced congestion control algorithm that utilizes multiple congestion indicators within the networking environment. An exemplary system may include an algorithmic (e.g., reinforcement) learning agent that employs a deep neural network for learning congestion control policies. The agent may interact with a distributed training component and operate across various simulated environments that replicate real-world benchmarks and hardware. The simulation may include the generation and collection of congestion indicators such as telemetry probes, packet drop indications, congestion notification packets, received pauses/transmit wait signals, and port utilization metrics. The collected congestion indicators may be used to form a comprehensive congestion state representation of the network. The congestion state representation may include real-time metrics of network congestion, which the agent uses to understand the current network conditions. The agent's actions may be evaluated based on a reward function that considers the congestion indicators, such as minimizing queue lengths and bandwidth utilization (from telemetry probes), reducing the frequency of packet drop indications, decreasing the number of congestion notification packets, limiting pauses and transmit wait times, and/or balancing port utilization metrics to ensure efficient use of network resources. The agent may employ a reinforcement learning algorithm, such as a deep neural network with policy gradients, which uses the state representation and reward function to update its policy. The policy dictates the agent's actions to optimize the network performance, balancing objectives like maximizing throughput, minimizing latency, and ensuring fairness.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “interconnected” may imply that each component is directly or indirectly linked to every other component or switch in the network, allowing for seamless data transfer and communication between all the components.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example System Environment

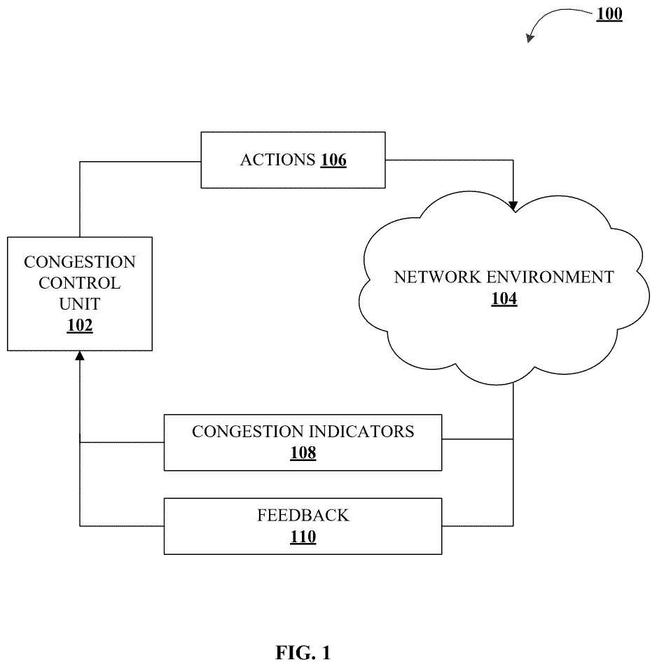

FIG. 1 illustrates an example system environment 100 for advanced congestion control, in accordance with an embodiment of the present invention. As shown in FIG. 1, the system environment 100 may include a congestion control unit 102 and a network environment 104.

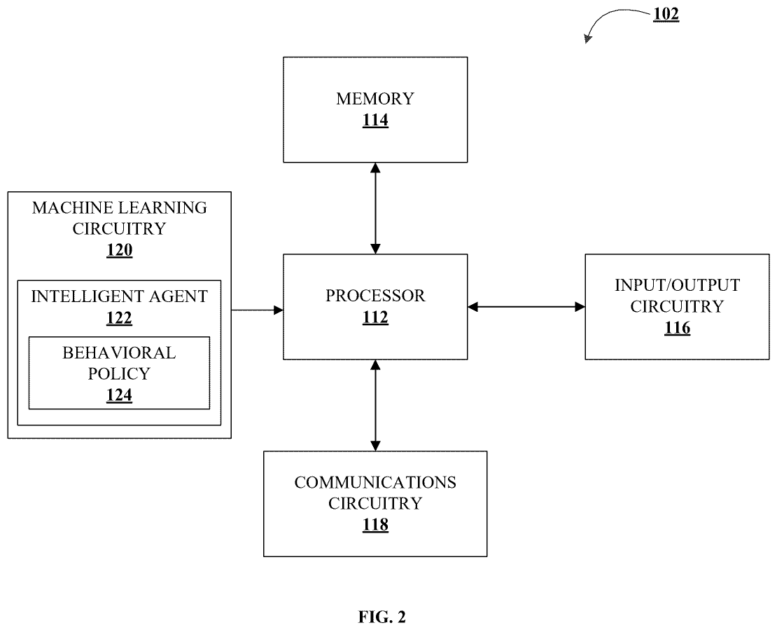

The congestion control unit 102 may be operatively coupled to the network environment 104 and configured to manage and mitigate network congestion within the network environment 104, as described in more detail with respect to FIG. 2. The congestion control unit 102 may capture congestion indicators 108 from the network environment 104. The congestion indicators 108 may include, but are not limited to, telemetry information, packet drop metrics, congestion notification packet rates, pause frame rates, and port utilization metrics. Based on the congestion indicators 108 the congestion control unit 102 may determine actions 106 to take to alleviate congestion within the network environment 104. These actions 106 may include adjusting the transmission rates of NICs, rerouting data traffic through alternative paths, temporarily pausing data transmission, reallocating network resources to balance the load more effectively, and/or the like. By implementing these actions 106, the congestion control unit 102 may prevent data bottlenecks and ensure smooth data flow across the network environment 104. Once the actions 106 are executed, the congestion control unit 102 may receive feedback 110 from the network environment 104. This feedback 110 may include updated congestion indicators and performance metrics, allowing the congestion control unit 102 to assess the effectiveness of the implemented actions 106. Based on this feedback 110, the congestion control unit 102 can alter future actions to continually optimize network performance. This iterative process ensures that the congestion control unit 102 adapts to changing network conditions and maintains an optimal balance between data throughput and network stability.

The network environment 104 may refer to an integrated system configured to support data transmission across a variety of interconnected devices. The network environment 104 may include a wide array of network devices, including servers, switches, routers, and other components embedded therewithin, such as network interface cards (NICs). These network devices may work in concert to facilitate the seamless exchange of data therebetween, ensuring robust network performance and reliability. In addition to the core network devices, the network environment 104 may also include various auxiliary components such as firewalls, load balancers, and network management systems. Firewalls may protect the network from unauthorized access and cyber threats, while load balancers distribute network traffic evenly across servers to prevent overload and ensure high availability. Network management systems may provide real-time monitoring and analytics, enabling administrators to oversee network performance, identify potential issues, and implement corrective measures promptly.

The network environment 104 may further include end-point devices that serve as user input devices, allowing users to access the network environment. These end-point devices may include, but are not limited to, personal computers, laptops, tablets, smartphones, and other mobile devices. Such devices enable users to interact with the network environment 104, accessing applications, data, and services hosted on the servers. These end-point devices are typically equipped with their own NICs, which facilitate connectivity to the network, either through wired connections, such as Ethernet®, or wireless connections, such as Wi-Fi®. End-point devices may also include specialized input devices such as keyboards, mice, touchscreens, and other peripherals that enhance user interaction with the network. By providing diverse access points and input methods, the network environment 104 ensures that users can seamlessly connect to and utilize network resources from various locations and contexts, thereby supporting a wide range of user needs, including network accessibility and usability.

It should be noted that the description of the network environment 104 provided herein is illustrative and not intended to be limiting. The scope of the network environment 104 is not restricted to the specific devices, configurations, or applications discussed above. Variations and modifications may be made without departing from the spirit and scope of the invention. The network environment 104 may encompass additional components, configurations, and functionalities that are not explicitly mentioned but fall within the general framework and objectives described. Any equivalent implementations or adaptations that achieve substantially the same results as the embodiments disclosed are considered to be within the scope of this invention. Furthermore, it is to be understood that the structure of the system environment 100 and its components, connections and relationships, and their functions, are meant to be exemplary only, and are not meant to limit implementations of the disclosures described and/or claimed in this document. In one example, the system environment 100 may include more, fewer, or different components. In another example, some or all of the portions of the system environment 100 may be combined into a single portion or all of the portions of the environment 100 may be separated into two or more distinct portions.

### Example Congestion Control Unit Circuitry

FIG. 2 illustrates an example congestion control unit 102 for congestion control, in accordance with an embodiment of the present invention. As shown in FIG. 2, the congestion control unit 102 may include a processor 112, a memory 114, input/output circuitry 116, communications circuitry 118, and machine learning circuitry 120.

Although the term “circuitry” as used herein with respect to components 112-120 is described in some cases using functional language, it should be understood that the particular implementations necessarily include the use of particular hardware configured to perform the functions associated with the respective circuitry as described herein. It should also be understood that certain of these components 112-120 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the congestion control unit 102 may be housed together, while other components are housed separately (e.g., a controller in communication with the congestion control unit 102). While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the congestion control unit 102 may provide or supplement the functionality of particular circuitry. For example, the processor 112 may provide processing functionality, the memory 114 may provide storage functionality, the communications circuitry 118 may provide network interface functionality, and the like.

In some embodiments, the processor 112 (and/or co-processor or any other processing circuitry assisting or otherwise associated with the processor) may be in communication with the memory 114 via a bus for passing information among components of, for example, the congestion control unit 102. The memory 114 may be non-transitory and may include, for example, one or more volatile and/or non-volatile memories, or some combination thereof. In other words, for example, the memory 114 may be an electronic storage device (e.g., a non-transitory computer readable storage medium). The memory 114 may be configured to store information, data, content, applications, instructions, or the like, for enabling an apparatus, e.g., the congestion control unit 102, to carry out various functions in accordance with example embodiments of the present disclosure.

Although illustrated in FIG. 2 as a single memory, the memory 114 may comprise a plurality of memory components. The plurality of memory components may be embodied on a single computing device or distributed across a plurality of computing devices. In various embodiments, the memory 114 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 114 may be configured to store information, data, applications, instructions, or the like for enabling the congestion control unit 102 to carry out various functions in accordance with example embodiments discussed herein. For example, in at least some embodiments, the memory 114 may be configured to buffer data for processing by the processor 112. Additionally, or alternatively, in at least some embodiments, the memory 114 may be configured to store program instructions for execution by the processor 112. The memory 114 may store information in the form of static and/or dynamic information. This stored information may be stored and/or used by the congestion control unit 102 during the course of performing its functionalities.

The processor 112 may be embodied in a number of different ways and may, for example, include one or more processing devices configured to perform independently. Additionally, or alternatively, the processor 112 may include one or more processors configured in tandem via a bus to enable independent execution of instructions, pipelining, and/or multithreading. The processor 112 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC) or field programmable gate array (FPGA), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, the processor 112 may include a plurality of processors. The plurality of processors may be embodied on a single computing device or may be distributed across a plurality of such devices collectively configured to function as the congestion control unit 102. The plurality of processors may be in operative communication with each other and may be collectively configured to perform one or more functionalities of the congestion control unit 102 as described herein.

In an example embodiment, the processor 112 may be configured to execute instructions stored in the memory 114 or otherwise accessible to the processor 112. Alternatively, or additionally, the processor 112 may be configured to execute hard-coded functionality. As such, whether configured by hardware or software methods, or by a combination thereof, the processor 112 may represent an entity (e.g., physically embodied in circuitry) capable of performing operations according to an embodiment of the present disclosure while configured accordingly. Alternatively, as another example, when the processor 112 is embodied as an executor of software instructions, the instructions may specifically configure the processor 112 to perform one or more algorithms and/or operations described herein when the instructions are executed. For example, these instructions, when executed by the processor 112, may cause the congestion control unit 102 to perform one or more of the functionalities thereof as described herein.

In some embodiments, the congestion control unit 102 may further include input/output circuitry 116 that may, in turn, be in communication with the processor 112 to provide an audible, visual, mechanical, or other output and/or, in some embodiments, to receive an indication of an input from a user or another source. In that sense, the input/output circuitry 116 may include means for performing analog-to-digital and/or digital-to-analog data conversions. The input/output circuitry 116 may include support, for example, for a display, touchscreen, keyboard, mouse, image capturing device (e.g., a camera), microphone, and/or other input/output mechanisms. The input/output circuitry 116 may include a user interface and may include a web user interface, a mobile application, a kiosk, or the like.

The processor 112 and/or user interface circuitry comprising the processor 112 may be configured to control one or more functions of a display or one or more user interface elements through computer-program instructions (e.g., software and/or firmware) stored on a memory accessible to the processor 112 (e.g., the memory 114, and/or the like). In some embodiments, aspects of input/output circuitry 116 may be reduced as compared to embodiments where the congestion control unit 102 may be implemented as an end-user machine or other type of device designed for complex user interactions. In some embodiments (like other components discussed herein), the input/output circuitry 116 may be eliminated from the congestion control unit 102. The input/output circuitry 116 may be in communication with memory 114, communications circuitry 118, and/or any other component(s), such as via a bus. Although more than one input/output circuitry and/or other component can be included in the congestion control unit 102, only one is shown in FIG. 2 to avoid overcomplicating the disclosure (e.g., as with the other components discussed herein).

The communications circuitry 118, in some embodiments, includes any means, such as a device or circuitry embodied in either hardware, software, firmware or a combination of hardware, software, and/or firmware, that is configured to receive and/or transmit data from/to a network and/or any other device, circuitry, or module associated therewith. In this regard, the communications circuitry 118 may include, for example, a network interface for enabling communications with a wired or wireless communication network. For example, in some embodiments, communications circuitry 118 may be configured to receive and/or transmit any data that may be stored by the memory 114 using any protocol that may be used for communications between computing devices. For example, the communications circuitry 118 may include one or more communication ports, network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 118 may include circuitry for interacting with the antenna(s) to cause transmission of signals via the antenna (e) or to handle receipt of signals received via the antenna (e). These signals may be transmitted by the congestion control unit 102 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 118 may additionally or alternatively be in communication with the memory 114, the input/output circuitry 116, and/or any other component of the congestion control unit 102, such as via a bus. The communication circuitry 118 of the congestion control unit 102 may also be configured to receive and transmit information to and from the various components associated therewith.

The congestion control unit 102 may also include machine learning circuitry 120 to enhance its ability to predict and manage network congestion. In this regard, the machine learning circuitry 120 may include an intelligent agent 122. The intelligent agent 122 may employ advanced machine learning techniques to analyze the congestion state of the network environment 104 and make informed decisions to manage congestion. The congestion state representation may be generated using real-time metrics obtained from congestion indicators (e.g., congestion indicators 108 in FIG. 1), such as telemetry information, packet drop metrics, congestion notification packet rate, pause frame rate, and port utilization metrics. The intelligent agent 122 may use this congestion state representation to understand the current conditions of the network environment 104 accurately, and subsequently implement actions (e.g., actions 106 in FIG. 1) to change the congestion state of the network environment 104 (e.g., mitigate congestion within the network environment 104).

The intelligent agent 122 may include a behavioral policy 124, embedded within the intelligent agent 122, configured to serve as the decision-making framework that dictates the actions (e.g., actions 106) the intelligent agent 122 may take in response to the congestion state representation. The behavioral policy 124 may be formulated based on the analysis of the congestion state representation, generated using congestion indicators. The behavioral policy 124 may map the observed congestion state to specific actions that aim to manage and mitigate network congestion. The intelligent agent 122 may be configured to be adaptive, continuously learning and updating its behavioral policy 124 based on real-time feedback (e.g., feedback 110) from the network environment 104.

In one example, the intelligent agent 122 may utilize a deep reinforcement learning framework, which combines deep learning with reinforcement learning principles. The deep learning component, typically implemented as a deep neural network (DNN), processes high-dimensional input data from the network environment 104 (e.g., congestion indicators 108) to extract relevant features and construct a comprehensive congestion state representation of the network environment 104. The reinforcement learning component may allow the intelligent agent 122 to optimize its behavioral policy 124 through trial and error, guided by a reward function that evaluates the effectiveness of its actions (e.g., actions 106). The reward function may consider various metrics, such as minimizing queue lengths, reducing packet loss, decreasing congestion notification packets, balancing port utilization, and/or the like. By iteratively refining its behavioral policy (e.g., behavioral policy 124) based on the rewards received, the intelligent agent 122 can learn to take actions to mitigate congestion and enhance network performance over time.

The intelligent agent 122 may be trained via deployment in various real-world network environments and/or simulated network environments (not shown) that replicate real-world conditions and congestion scenarios, collectively referred to as training environments. These training environments may be configured to expose the intelligent agent 122 to a wide range of network states and congestion events, allowing intelligent agent 122 to gather diverse experiences. Such training environments may include different network topologies, varying traffic loads, diverse congestion patterns, multiple network protocols, and/or the like. During the training phase, the intelligent agent 122 may interact with the training environments by taking actions based on an initial behavioral policy. The outcomes of these actions may be observed, and feedback may be provided to the intelligent agent 122 in the form of rewards or penalties. The reward function may evaluate the effectiveness of the intelligent agent's 122 actions by considering metrics such as queue lengths, packet loss rates, congestion notification packet rates, pause frame rates, and port utilization. Positive rewards may be given for actions that improve performance of the training environments, while negative rewards may be assigned for actions that exacerbate congestion. As the intelligent agent 122 accumulates experience through its interactions with the training environments, the intelligent agent 122 may update its behavioral policy to improve its decision-making capabilities. The process of updating the behavioral policy may involve adjusting the parameters of the underlying machine learning model, such as the weights of a deep neural network in the case of deep reinforcement learning. The intelligent agent 122 may use algorithms like policy gradients or Q-learning to iteratively refine the behavioral policy 124 based on the received rewards, progressively enhancing its ability to manage congestion. The training process may be iterative and continuous, allowing the intelligent agent 122 to learn from an extensive set of scenarios and gradually develop a robust behavioral policy (e.g., behavioral policy 124). The intelligent agent's 122 performance may be periodically evaluated in the training environments to ensure progress towards optimal congestion management. In some cases, the training environments can be adjusted, as needed, to introduce new challenges or to focus on specific areas where the intelligent agent's 122 performance needs improvement.

Once the intelligent agent 122 has demonstrated sufficient competence (e.g., based on benchmarks and key performance indicators (KPIs) such as the reduction in average queue lengths, decrease in packet loss rates, improvement in overall network throughput, and consistency in maintaining low latency) in the training environments, the intelligent agent 122 can be deployed in a live network environment (e.g., network environment 104). Even after deployment, the intelligent agent 122 may continue to learn and adapt its behavioral policy 124 based on real-time feedback from the network environment (e.g., network environment 104) in which it is deployed. This ongoing learning process may ensure that the intelligent agent 122 remains effective in managing congestion under changing network conditions and evolving traffic patterns.

It should be understood that the intelligent agent 122 is not limited to the use of a deep reinforcement learning framework. Any machine learning model capable of analyzing network state data and making informed decisions to manage congestion may be used within the scope of the present invention. Examples of such models include, but are not limited to, supervised learning models, unsupervised learning models, other reinforcement learning models, decision tree-based models, support vector machines, Bayesian networks, and ensemble learning methods. Additionally, the intelligent agent 122 may employ any combination of these models to optimize its decision-making process.

In some embodiments, the congestion control unit 102 may include hardware, software, firmware, and/or a combination of such components, configured to support various aspects of machine learning circuitry 120 as described herein. It should be appreciated that in some embodiments, the machine learning circuitry 120 may perform one or more of such example actions in combination with another circuitry of the congestion control unit 102, such as the memory 114, processor 112, input/output circuitry 116, and/or communications circuitry 118. For example, in some embodiments, the machine learning circuitry 120 may utilize the processing circuitry, such as the processor 112 and/or the like, to form a self-contained subsystem to perform one or more of its corresponding operations. In a further example, and in some embodiments, some or all of the functionality of the machine learning circuitry 120 may be performed by the processor 112. In this regard, some or all of the example processes and algorithms discussed herein can be performed by at least one processor 112, and/or the machine learning circuitry 120. It should also be appreciated that, in some embodiments, the machine learning circuitry 120 may include a separate processor, specially configured FPGA, or ASIC to perform its corresponding functions. Additionally, or alternatively, in some embodiments, the machine learning circuitry 120 may use the memory 114 to store collected information. For example, in some implementations, the machine learning circuitry 120 may include hardware, software, firmware, and/or a combination thereof, that interacts with the memory 114 to send, retrieve, update, and/or store data.

Accordingly, non-transitory computer readable storage media, which may, for example, be the memory 114, can be configured to store firmware, one or more application programs, and/or other software, which include instructions and/or other computer-readable program code portions that can be executed to direct operation of the congestion control unit 102 to implement various operations, including the examples described herein. As such, a series of computer-readable program code portions may be embodied in one or more computer-program products and can be used, with a device, congestion control unit 102, database, and/or other programmable apparatus, to produce the machine-implemented processes discussed herein. It is also noted that all or some of the information discussed herein can be based on data that is received, generated and/or maintained by one or more components of the congestion control unit 102. In some embodiments, one or more external systems (such as a remote cloud computing and/or data storage system) may also be leveraged to provide at least some of the functionality discussed herein.

It should be recognized that the structure of the congestion control unit 102, as detailed herein, represents merely one embodiment among a multitude of potential configurations. This particular structure of the congestion control unit 102 is delineated to demonstrate a specific arrangement and interaction of its components that collectively contribute to its comprehensive network capabilities. However, this outlined configuration is not definitive or limiting. Variations and modifications may be made to the configuration, connection, and interaction of the components within the congestion control unit 102 without departing from the scope of the invention. The described embodiment is intended for illustrative purposes, and any equivalent structures or methods that perform substantially the same function as the described embodiment are considered within the scope of this invention. The appended claims are intended to cover such variations and modifications as would occur to those skilled in the art.

### Example Network Environment

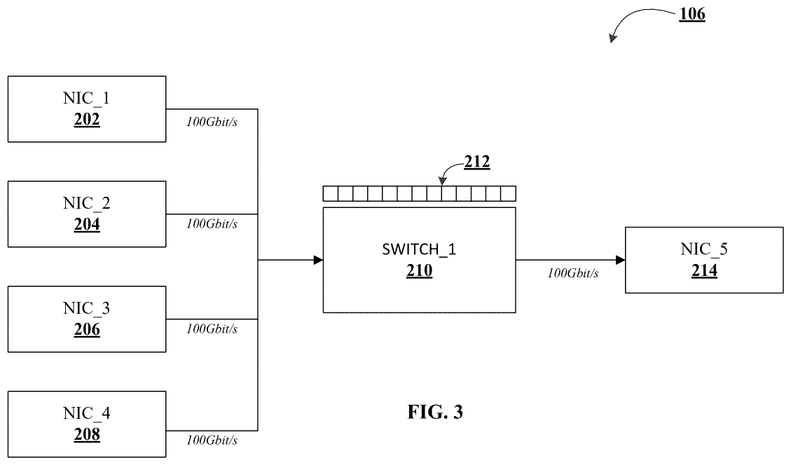

FIG. 3 illustrates an example network environment 104, in accordance with an embodiment of the invention. As shown in FIG. 3, the network environment 104 may include a plurality of transmitting network interface cards (NICs), NIC_1 202, NIC_2 204, NIC_3 206, and NIC_4 208, a switch, SWITCH_1 210, a buffer 212, and a receiving NIC, NIC_5 214.

NICs may be specialized components embedded within various network devices such as servers, workstations, and networked storage devices that are responsible for facilitating data transmission and reception across the network environment. In an example embodiment, NIC_1 202, NIC_2 204, NIC_3 206, and NIC_4 208 may be transmitting NICs embedded within different servers or other network devices, each capable of transmitting data at a rate of up to 100 Gbits/s. The transmitting NICs may work in tandem to send data to receiving NIC NIC_5 214, via SWITCH_1 210.

SWITCH_1 210 may serves as an intermediary device managing the data flow. The SWITCH_1 210 may receive data from the transmitting NICs, NIC_1 202, NIC_2 204, NIC_3 206, and NIC_4 208, and direct the data towards the appropriate destination, such as receiving NIC, NIC_5 214. In specific embodiments, the SWITCH_1 210 may utilize a buffer 212 to temporarily store data packets when necessary to manage traffic and prevent data loss. In an example embodiment, the SWITCH_1 210 may have a combined inbound capacity of up to 400 Gbits/s from the four transmitting NICs, but its maximum outbound rate may be limited to 100 Gbits/s. Such a configuration may create a potential congestion point within the network environment 104.

It should be understood that the network environment 104 illustrated in FIG. 3 is provided for illustrative purposes only and is not intended to limit the scope of the invention. The specific configuration and components depicted, including the transmitting NICs (NIC_1 202, NIC_2 204, NIC_3 206, and NIC_4 208), the switch (SWITCH_1 210), the buffer 212, and the receiving NIC (NIC_5 214), represent just one of many possible embodiments of the network environment. Variations in the arrangement, quantity, and types of components used in the network environment 104 may be made without departing from the spirit and scope of the invention. Alternative configurations may include additional or different network devices, varying numbers of NICs, or alternative methods for managing data flow and congestion.

### Example Method for Advanced Congestion Control

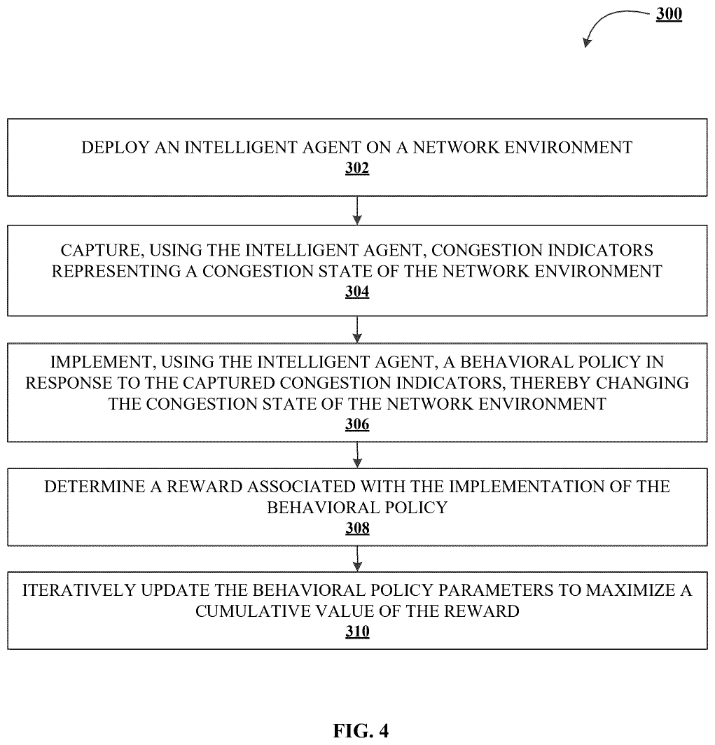

FIG. 4 illustrates an example method for advanced congestion control, in accordance with an embodiment of the invention. As shown in block 302, an intelligent agent may be deployed on a network environment. The intelligent agent may be deployed within the network environment to monitor and manage network congestion. As described herein, the intelligent agent may employ advanced machine learning techniques to analyze the congestion state of the network environment and make informed decisions to manage congestion.

As shown in block 304, congestion indicators that represent a congestion state of the network environment may be captured. Upon deployment, the intelligent agent may capture congestion indicators within the network environment. Congestion indicators may be various metrics and signals that reflect the current state of traffic and congestion within a network environment. The congestion indicators may include, telemetry information, packet drop metrics, congestion notification packet rates, pause frame rates, port utilization metrics, and/or the like.

Telemetry information may refer to set of signals extracted from network devices (e.g., SWITCH_1 210 in FIG. 3) and is observable only by those devices. Examples of telemetry information may include port utilization metrics, queue lengths, queuing delays, link throughput, estimated number of concurrent flows, packet discard counters, flow control pause counters, the topology location of congestion information, and/or the like.

Port utilization metrics may refer to how many ports of a particular network device are being used at any given instant. Port utilization may provide a snapshot of the network device's activity level and capacity usage. High port utilization may indicate that a significant portion of the network device's ports are active, which can signal potential congestion issues. Monitoring port utilization allows for identification of bottlenecks where too many ports are being used simultaneously, potentially overwhelming the network device's processing capabilities and leading to congestion. Port utilization can be measured through various means, including the number of active ports relative to the total number of available ports, the bandwidth consumed by each port, and the data throughput handled by the network device. As such, port utilization may provide a comprehensive view of how network resources are being utilized and can inform decisions about scaling, traffic management, and quality of service (QoS) policies.

Queue length metric may refer to the total size of data packets waiting in the input queue of a particular network device. In embodiments where data transmission encounters multiple network devices, the queue length metric may be a combined value of the total size of data packets waiting in each queue of each network device. The combined value may be determined using methods such as maximum, average, median, or other statistical measures. For instance, the maximum queue length metric may reflect the size of the largest queue encountered along the data transmission path, providing insight into potential bottlenecks. The average queue length metric may offer an overall perspective on network congestion by averaging the sizes of all queues. The median queue length metric, on the other hand, may represent the middle value of the queue sizes, reducing the impact of outliers and providing a more robust measure of central tendency. Additional methods for determining the combined queue length metric may include weighted averages, where certain network devices may be given higher significance based on their role or importance in the network. Other techniques, such as moving averages or exponential smoothing, can be employed to account for temporal variations and provide a dynamic assessment of network conditions.

Queuing delay may refer to the time data packets spend waiting in the queue before being processed by a network device. Queuing delay metric can provide insights into network congestion and performance by measuring the latency introduced at various points in the network. Queuing delay can be monitored at individual network devices or aggregated across multiple devices to understand the overall delay encountered by data packets.

Link throughput may be measured in bytes per second and represents the actual data transmission rate over a network link. Unlike link utilization, which is expressed as a percentage, link throughput may provide a quantifiable measure of the volume of data successfully transmitted. Link throughput may be used for assessing the efficiency and capacity of network links, identifying potential bottlenecks, and optimizing data flow. A flow may be defined by a 5-tuple comprising the source and destination IP addresses, source and destination ports, and protocol type. Monitoring the number of concurrent flows can reveal the network's load and usage patterns, helping in capacity planning and detecting anomalies or potential security threats. Packet discard counters may track the number of data packets that are dropped by network devices due to various reasons such as buffer overflow, errors, or policy enforcement. Flow control pause counters may record the instances where flow control mechanisms are activated to temporarily halt data transmission. The topology location of congestion information may identify where congestion occurs in the network topology, such as uplink versus downlink or at specific switch levels in a fat-tree topology. The format of this information can vary depending on the network topology, providing a detailed view of congestion patterns and enabling targeted troubleshooting and optimization efforts.

Packet drop metrics may measure the number of data packets that are lost or discarded as they traverse the network. Packet drop metrics may be used to assess network reliability and performance, as high packet drop rates can indicate issues such as network congestion, hardware failures, or suboptimal routing. Packet drop metrics may include one of out-of-order (OOO) negative acknowledgements (NACKs), three-consecutive acknowledgements (ACKs), explicit and/or deliberate drop indications, and/or the like. OOO packets may refer to packets that arrive at their destination in a sequence different from the order in which they were sent. This can happen due to varying paths taken by packets or due to processing delays within network devices (for example, due to network congestion). OOO packets can lead to retransmissions if the receiving system interprets them as lost, thus affecting network efficiency. Monitoring OOO packets may help in diagnosing issues related to path variability and ensuring that the sequence integrity of data is maintained. NACKs may refer signals sent by the receiving end to indicate that a packet was not received correctly or was lost. NACKs may prompt the sender to retransmit the specific packet. The presence of a high number of NACKs can be a strong indicator of poor network performance, network congestion, instability, and/or the like. By analyzing NACK metrics, network administrators can identify patterns or specific conditions that lead to packet loss. In many transmission protocols, receiving three consecutive ACKs for the same packet may be a signal to the sender that a packet was likely lost. Three-consecutive ACKs may trigger a retransmission of the suspected lost packet. Explicit and/or deliberate drop indications may occur when network devices deliberately discard packets due to reasons such as congestion, policy enforcement, or prioritization of critical traffic. Explicit drop indications can be valuable for understanding how network policies and configurations impact packet delivery. Deliberate drop metrics can reveal if the network is dropping packets as intended to maintain performance, or if there are unintended side effects leading to unnecessary packet loss.

Congestion notification packet rates may refer to the rate at which congestion notification packets are sent to signal congestion. The rate at which these packets are sent can provide a clear signal of congestion levels. Congestion notification packet rate may include a congestion notification type, such as Explicit Congestion Notification (ECN). ECN may be special packets that are used by various network protocols to signal congestion. The congestion notification type may be based on the network environment. In other words, the specific type of congestion notification packet employed, as well as the corresponding transmission rate, may be specific to the characteristics and operational requirements of the network. For instance, in a high-throughput environment, a different ECN configuration might be used compared to a latency-sensitive network. Pause frame rates may be used to control the flow of data and prevent buffer overflow in various network environments (e.g., network environments that use Ethernet). The frequency of pause frames can indicate the level of congestion in the network. Port utilization metrics at a receiving network device (e.g., NIC_5 214 in FIG. 3) may measure the utilization rate of the network ports of the receiving network device, showing how much of the available bandwidth is being used at any given time.

Other congestion indicators may include round-trip time (RTT) and latency, in-band flow analysis (IFA), queue lengths and buffer occupancy, and/or the like. RTT and latency may measure the time it takes for a data packet to travel from the source to the destination and back. Increased RTT and latency values often suggest network congestion, as packets take longer to traverse the network due to queuing delays. IFA may involve analyzing data packets as they travel through the network to gather information about flow characteristics and performance. IFA can help identify congestion points and traffic patterns that contribute to network slowdowns. Queue lengths and buffer occupancy (e.g., buffer occupancy in buffer 212 in FIG. 2) may provide insight into congestion levels. Long queues and high buffer occupancy typically indicate that the network is struggling to process the volume of traffic efficiently. The congestion indicators may be used to generate a comprehensive congestion state representation of the network environment, which may be used to diagnose network performance issues and serve as a foundation for congestion mitigation decision-making.

As shown in block 306, a behavioral policy may be implemented in response to the captured congestion indicators, thereby changing the congestion state of the network environment. As described herein with respect to FIG. 2, the behavioral policy may be configured to serve as the decision-making framework that dictates actions to be taken in response to the captured congestion indicators. In an example embodiment, the actions to be taken may be determined based on behavioral policy parameters. The behavioral policy parameters may refer to specific rules, criteria, or models associated with the behavioral policy that define how the intelligent agent interprets the congestion indicators and determines appropriate actions to manage and mitigate congestion.

The behavioral policy parameters may fine-tuned and updated during the training phase of the intelligent agent. As described herein, the intelligent agent may be trained via deployment in both real-world network environments and simulated environments that replicate real-world conditions and congestion scenarios. These training environments may be configured to expose the intelligent agent to a wide range of network states and congestion events, allowing the intelligent agent to gather diverse experiences. During training, the intelligent agent may interact with these training environments by taking actions based on an initial behavioral policy with an initial set of behavioral policy parameters. As the intelligent agent accumulates experience through its interactions with the training environments, the intelligent agent may update its behavioral policy and the behavioral policy parameters to improve its decision-making capabilities.

Implementing the behavioral policy may include determining, using behavioral policy parameters, actions to be executed in response to the captured congestion indicators, and executing the actions in the network environment. The implementation process may involve analyzing the captured congestion indicators to ascertain the current state of the network environment. Based on the analysis of the captured congestion indictors, the behavioral policy parameters may facilitate the determination of specific actions aimed at managing and mitigating congestion. These actions may include adjusting network resource allocation, modifying data packet routing paths, prioritizing certain network traffic types, deploying congestion control mechanisms, and/or the like. The intelligent agent may continuously monitor the effectiveness of these actions and update the behavioral policy in real-time based on feedback from the network environment. Such an adaptive approach allows the intelligent agent can respond dynamically to network changes, maintaining optimal performance and preventing congestion from degrading the quality of service. The ongoing learning process may allow the intelligent agent to refine its decision-making framework.

As shown in block 308, a reward may be determined for the implementation of the behavioral policy. Determining the reward may include executing a reward function for at least a subset of the captured congestion indicators (e.g., telemetry information, packet drop metrics, and/or the like) based on the corresponding subset of executed actions. This process may include selecting relevant congestion indicators that reflect aspects of network performance and applying a predefined reward function to evaluate the impact of the executed actions on these indicators. Such an evaluation may measure the extent to which each action may have influenced the network congestion, cither by improving or worsening the network congestion.

In one example, the reward function for the telemetry information may be r(c₁)=−(qlen*transmissionrate−target)²−(maximumutil−util)². In one aspect, qlen may be queue length indicating a total size of data packets waiting in an output queue at each network device. In another aspect, qlen may be the queue length indicating the total size of data packets waiting in the output queue of a network device experiencing maximum congestion. transmissionrate may be a rate at which data packets are transmitted within the network environment. target may be a predefined value representing a desired product of qlen and transmissionrate. maximumutil may be a maximum potential port utilization indicating full bandwidth usage. In one aspect, util may be current port utilization associated with the one or more network devices indicating network traffic as a percentage of maximum potential bandwidth. In another aspect, util may be current port utilization associated with a network device indicating maximum bandwidth utilization.

In another example, the reward function for packet drop metrics may be r(c₂)=−(packetdroprate)²+transmissionrate. Herc, packetdroprate may include a rate at which data packets are dropped in the network environment. In yet another example, the reward function for pause frame rate may be r(c₃)=−(pauserate)²+transmissionrate. Here, pauserate may be a number of pause frames received. In still other examples, the reward function for congestion notification packet rate may include r(c₄)=−(CNPrate)²+transmissionrate. Here, CNPrate may be a number of congestion notification packets received. In still other examples, the reward function for port utilization metric associated with each destination network device and a round-trip time associated with data packets transmitted from and/or received by each destination network device may be r(c₅)=(networkportutilization)²+transmissionrate−(RTTsample−targetRTT)². Here, networkportutilization may be a port utilization rate of each destination network device; RTTsample may be a measured sample of round-trip time associated with data packets transmitted from and/or received by each destination network device; and targetRTT may be a predefined target value for round-trip time associated with data packets transmitted from and/or received by each destination network device.

Calculating the reward value for the congestion indicators may translate the observed effects of the actions executed using the behavioral policy into a numerical reward value, providing a quantifiable metric for assessing the efficacy of the actions in alleviating network congestion. The reward value thus derived may enable network administrators to make informed decisions about optimizing network management strategies.

As shown in block 310, behavioral policy parameters may be iteratively updated to maximize a cumulative value of the reward. Iteratively updating the behavioral policy parameters may include continuously adjusting the parameters that guide the network's behavior based on the feedback obtained from the reward values. Each iteration may leverage the reward values, which are calculated based on the effectiveness of previously executed actions, as described herein, to refine and optimize the policy parameters. The iterative updating process may employ optimization algorithms, such as gradient descent, or other machine learning techniques, to evaluate the current behavioral policy parameters against the observed rewards. These algorithms may identify potential improvements by analyzing the impact of the actions taken and adjusting the parameters to enhance performance. The primary objective of this process may be to incrementally maximize the reward for each action, ensuring that the network continuously learns and adapts to optimize its performance. Through repeated iterations, the network's behavioral policy may become more adept at managing traffic, reducing congestion, and improving data transmission efficiency. The cumulative reward may reflect the overall success of these strategies, guiding the system towards sustained improvements in network management and performance.

The reward functions provided herein are presented by way of example only and are not intended to be exhaustive or limiting in scope. It is expressly contemplated that other reward functions may be utilized in accordance with the principles set forth herein, and such alternative reward functions are considered to fall within the purview of the present disclosure. Accordingly, the specific examples provided should not be construed to limit the broad applicability of the reward function framework to other network metrics or performance indicators that may be deemed appropriate by one of ordinary skill in the art.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases the method may include additional steps. The steps and modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A congestion control unit for network congestion control, the congestion control unit configured to:
deploy an intelligent agent on a network environment;
capture, using the intelligent agent, congestion indicators representing a congestion state of the network environment, wherein the congestion indicators comprise at least telemetry information associated with one or more network devices in the network environment; and
implement, using the intelligent agent, a behavioral policy in response to the captured congestion indicators, thereby changing the congestion state of the network environment.

2. The congestion control unit of claim 1, wherein implementing the behavioral policy further comprises:
determining, using behavioral policy parameters, actions to be executed in response to the captured congestion indicators; and
executing the actions in the network environment.

3. The congestion control unit of claim 2, wherein the congestion control unit is further configured to:
determine a reward associated with the implementation of the behavioral policy; and
iteratively update the behavioral policy parameters to maximize a cumulative value of the reward.

4. The congestion control unit of claim 3, wherein determining the reward further comprises:
executing a reward function for at least a subset of the captured congestion indicators based on the corresponding subset of executed actions; and
calculating a reward value for the subset of executed actions based on executed reward function.

5. The congestion control unit of claim 4, wherein the reward function for the telemetry information associated with one or more network devices in the network environment comprises:
$$r ( {c}_{1} ) = - {( qlen * transmissionrate - target )}^{2} - {( maximumutil - util )}^{2} ,$$
wherein qlen is a queue length indicating a total size of data packets waiting in an output queue at each network device, wherein transmissionrate is a rate at which data packets are transmitted within the network environment, wherein target is a predefined value representing a desired product of qlen and transmissionrate, wherein maximumutil is maximum potential port utilization indicating full bandwidth usage, and wherein util is current port utilization associated with the one or more network devices indicating network traffic as a percentage of maximum potential bandwidth.

6. The congestion control unit of claim 5, wherein qlen is the queue length indicating the total size of data packets waiting in the output queue of a network device experiencing maximum congestion, and wherein util is current port utilization associated with a network device indicating maximum bandwidth utilization.

7. The congestion control unit of claim 5, wherein the captured congestion indicator comprises packet drop metrics, and wherein the reward function for the packet drop metrics comprises:
r(c₂)=−(packetdroprate)²+transmissionrate, wherein packetdroprate comprises a rate at which data packets are dropped in the network environment.

8. The congestion control unit of claim 7, wherein the packet drop metrics comprise at last one of out-of-order (OOO) negative acknowledgements (NACKs), three-consecutive acknowledgements (ACKs), or explicit and/or deliberate drop indications.

9. The congestion control unit of claim 5, wherein the captured congestion indicator comprises pause frame rate, wherein the reward function for the pause frame rate comprises:
r(c₃)=−(pauserate)²+transmissionrate, wherein pauserate is a number of pause frames received.

10. The congestion control unit of claim 5, wherein the captured congestion indicator comprises congestion notification packet rate, and wherein the reward function for the congestion notification packet rate comprises:
r(c₄)=−(CNPrate)²+transmissionrate, wherein CNPrate is a number of congestion notification packets received.

11. The congestion control unit of claim 10, wherein the congestion notification packet rate comprises a congestion notification type, wherein the congestion notification type is based on at the network environment.

12. The congestion control unit of claim 5, wherein the captured congestion indicator comprises a port utilization metric associated with each destination network device and a round-trip time associated with data packets transmitted from and/or received by each destination network device, and wherein the reward function for the port utilization metric comprises:
r(c₅)=(networkportutilization)²+transmissionrate−(RTTsample−targetRTT)², wherein networkportutilization is a port utilization rate of each destination network device, RTTsample is a measured sample of round-trip time associated with data packets transmitted from and/or received by each destination network device, wherein targetRTT is a predefined target value for round-trip time associated with data packets transmitted from and/or received by each destination network device.

13. A method for network congestion control, the method comprising:
deploying an intelligent agent on a network environment;
capturing, using the intelligent agent, congestion indicators representing a congestion state of the network environment, wherein the congestion indicators comprise at least telemetry information associated with one or more network devices in the network environment; and
implementing, using the intelligent agent, a behavioral policy in response to the captured congestion indicators, thereby changing the congestion state of the network environment.

14. The method of claim 13, wherein implementing the behavioral policy further comprises:
determining, using behavioral policy parameters, actions to be executed in response to the captured congestion indicators; and
executing the actions in the network environment.

15. The method of claim 14, wherein the method further comprises:
determining a reward associated with the implementation of the behavioral policy; and
iteratively updating the behavioral policy parameters to maximize a cumulative value of the reward.

16. The method of claim 15, wherein determining the reward further comprises:
executing a reward function for at least a subset of the captured congestion indicators based on the corresponding subset of executed actions; and
calculating a reward value for the subset of executed actions based on executed reward function.

17. The method of claim 16, wherein the reward function for the telemetry information associated with one or more network devices in the network environment comprises:
$$r ( {c}_{1} ) = - {( qlen * transmissionrate - target )}^{2} - {( maximumutil - util )}^{2} ,$$
wherein qlen is a queue length indicating a total size of data packets waiting in an output queue at each network device, wherein transmissionrate is a rate at which data packets are transmitted within the network environment, wherein target is a predefined value representing a desired product of qlen and transmissionrate, wherein maximumutil is maximum potential port utilization indicating full bandwidth usage, and wherein util is current port utilization associated with the one or more network devices indicating network traffic as a percentage of maximum potential bandwidth.

18. A computer program product for network congestion control, the computer program product comprising a non-transitory computer-readable medium comprising code configured to cause an apparatus to:
deploy an intelligent agent on a network environment;
capture, using the intelligent agent, congestion indicators representing a congestion state of the network environment, wherein the congestion indicators comprise at least telemetry information associated with one or more network devices in the network environment; and
implement, using the intelligent agent, a behavioral policy in response to the captured congestion indicators, thereby changing the congestion state of the network environment.

19. The computer program product of claim 18, wherein the code to implement the behavioral policy further causes the apparatus to:
determine, using behavioral policy parameters, actions to be executed in response to the captured congestion indicators; and
execute the actions in the network environment.

20. The computer program product of claim 19, wherein the code further causes the apparatus to:
determine a reward associated with the implementation of the behavioral policy; and
iteratively update the behavioral policy parameters to maximize a cumulative value of the reward.
